(19) United States
(12) Patent Application Publication
(10) Pub. No.: US 2023/0251227 A1
(43) Pub. Date: Aug. 10, 2023

(54) NON-DESTRUCTIVE TESTING METHOD FOR CICC SUPERCONDUCTING CABLE DAMAGE ESTIMATION

(71) Applicant: HEFEI INSTITUTES OF PHYSICAL SCIENCE, CHINESE ACADEMY OF SCIENCES, Hefei, Anhui (CN)

(72) Inventors: Xiaochuan LIU, Hefei (CN); Jinggang Qin, Hefei (CN); Chao ZHOU, Hefei (CN); Yu WU, Hefei (CN); Jiangang LI, Hefei (CN)

(73) Assignee: HEFEI INSTITUTES OF PHYSICAL SCIENCE, CHINESE ACADEMY OF SCIENCES, Hefei, Anhui (CN)

(21) Appl. No.: 17/922,463

(22) PCT Filed: May 14, 2020
(86) PCT No.: PCT/CN2020/090153

§ 371 Date: Apr. 19, 2023

(30) Foreign Application Priority Data
Apr. 30, 2020 (CN) 202010362234.6

(51) Int. Cl. G01N 27/82; G06F 30/20

(52) U.S. Cl. CPC G01N 27/82; G06F 30/20; G06F 2113/16

(57) ABSTRACT

The embodiments of the present invention relate to a non-destructive testing method for CICC superconducting cable damage estimation. The non-destructive testing method comprises the following steps: a modelling step of building a spatial model for a cable test piece, and determining, on the basis of the spatial model, a mutual relation between a current source in the cable test piece and a magnetic field around the cable test piece; a programming step of parsing the mutual relation, and programming a current source reconstruction program on the basis of the parsing process; a pick-up step of picking up a magnetic field signal around a superconducting cable by using a plurality of magnetic sensors; an inversion step of inputting the magnetic field signal into the current source reconstruction program, and then performing inversion to obtain a current source distribution in the superconducting cable; and an estimation step of estimating damage to the superconducting cable according to the current source distribution in the superconducting cable. According to the embodiments of the present invention, non-destructive testing of a CICC superconducting cable in a low-temperature environment can be realized.

### FIELD OF THE INVENTION

The invention relates to the technical field of non-destructive testing, in particular to a non-destructive testing method for superconducting cables in a low temperature environment.

### BACKGROUND OF THE INVENTION

Cable-In-Conduit conductors (CICC) are widely used in the field of magnetic confinement nuclear fusion, such as large superconducting magnets, large energy storage magnets, large superconducting strong magnetic field magnets, etc. CICC mainly includes a superconducting cable and a stainless steel jacket to protect and support the superconducting cable. Superconducting cable is the core component of CICCs which carries the current during its operation. The superconducting cable is generally made of superconducting wire(s) and other metal wire(s) (such as copper wires) through 3 to 5 levels of twisting or stranding, forming a low-porosity, multi-strand and multi-level helical structure. In the process of manufacture and operation, the superconducting cable is easy to cause partial damage or even strand breakage of the superconducting cable during the complex manufacture process, which seriously threatens the performance of the magnet and the safe operation of the device.

At present, testing to the superconducting cable is usually carried out by intercepting a section of superconducting cables; that is, performing a destructive test on the superconducting cable. Such destructive test method presents a high cost and poor economy. Due to the complex and multi-level composite structure of the superconducting cable, it is difficult to apply usual non-destructive testing techniques to the superconducting cable. For example, the microfocus X-ray detection technique needs to quantitatively identify damage to the superconducting wire(s) in the superconducting cable, which involves a high cost; besides, this technique is only suitable for the superconducting cable with a length of less than 500 mm. In addition, the superconducting cable carries current during operation, and the heat generated by the current will affect the electromagnetic field inside and around the superconducting cable, thereby causing interference to non-destructive testing for the superconducting cable. Therefore, it is a problem to be solved in the art to realize a non-destructive testing method for the superconducting cable.

The information disclosed in the Background is only for enhancement of understanding of the general background of the invention and may not be taken as an acknowledgement or any form of suggestion that this information forms the prior art already known to a person skilled in the art.

### CONTENTS OF THE INVENTION

In view of the above problem, the object of the present invention is to provide a non-destructive testing method that may be applied to superconducting cables.

According to an aspect of the invention, a non-destructive testing method for damage assessment for a superconducting cable is provided, which comprises the following steps: a modeling step of building a spatial model of a cable specimen and determining a relationship between a current source inside the cable specimen and a magnetic field around the cable specimen based on the spatial model; a programming step of analyzing the relationship and obtaining a current source reconstruction program based on the analyzation; a pick-up step of using a plurality of magnetic sensors to pick up magnetic field signals around the superconducting cable; an inversion step of inputting the magnetic field signals into the current source reconstruction program, so as to obtain a current source distribution inside the superconducting cable by inversion; and an assessing step of assessing damage to the superconducting cable according to the current source distribution inside the superconducting cable.

Optionally, the modeling step comprises: dividing components of the cable specimen into a plurality of levels, and performing level-by-level modeling from a lower level to a higher level during building the spatial model.

Optionally, the modeling step comprises: setting modeling weights on the components of the cable specimen, and applying the modeling weights to building the spatial model.

Optionally, the cable specimen comprises an overlapped wrapping tape and a central helical tube, and the modeling weights for the overlapped wrapping tape and the central helical tube are set to zero.

Optionally, the plurality of magnetic sensors form a circular magnetic sensor array on a plane perpendicular to an axis of the superconducting cable, and are uniformly distributed in a circumferential direction, so as to pick up the magnetic field signals on a cross-section of the superconducting cable.

Optionally, during the pick-up step, the superconducting cable or its part to be tested is placed in liquid nitrogen or liquid helium.

Optionally, the circular magnetic sensor array comprises 24 to 48 magnetic sensors.

Optionally, the magnetic field signals comprise a magnitude of magnetic field strength.

Optionally, a distance between each of the plurality of magnetic sensors and the superconducting cable is 1 mm to 10 mm.

Optionally, the pick-up step further comprises: moving the circular magnetic sensor array relative to the superconducting cable in an axial direction of the superconducting cable, or moving the superconducting cable relative to the circular magnetic sensor array in the axial direction of the superconducting cable, and picking up the magnetic field signals around the superconducting cable at a predetermined rate.

Optionally, a moving speed of the circular magnetic sensor array or the superconducting cable is 0.5 m/min to 10 m/min.

The non-destructive testing method for cables according to the embodiments of the present invention may realize non-destructive testing to superconducting cables, for example, non-destructive testing to Nb₃Sn (triniobium tin) CICC superconducting cables in a low temperature environment.

### DESCRIPTION OF THE DRAWINGS

FIG. 1 is a schematic perspective view of a typical CICC to which a non-destructive testing method of damage assessment for a CICC superconducting cable according to an embodiment of the present invention may be applied.

FIG. 2 is a schematic cross-sectional view of a typical CICC to which a non-destructive testing method for damage assessment for a CICC superconducting cable according to an embodiment of the present invention may be applied.

FIG. 3 is a schematic diagram of an implementation scenario of a non-destructive testing method for damage assessment for a CICC superconducting cable according to an embodiment of the present invention.

FIG. 4 is a schematic diagram of an implementation process of a non-destructive testing method for damage assessment for a CICC superconducting cable according to an embodiment of the present invention, showing the arrangement of a superconducting cable and a magnetic sensor array.

FIG. 5 is a flowchart of a non-destructive testing method for damage assessment for a CICC superconducting cable according to an embodiment of the present invention.

For clear description, parts that are not closely related to the technical essence of the present invention are omitted; and in the description and the drawings, the same or similar elements are denoted by the same reference number. It should be understood that the accompanying drawings present a somewhat simplified representation in order to illustrate the basic principles and various features of the present invention, and the scope of the present invention is not limited to the form represented in the drawings.

### DETAILED DESCRIPTION OF THE EMBODIMENTS

Embodiments of the present invention will be described in detail below with reference to the accompanying drawings. While the invention has been described in conjunction with the exemplary embodiments, it should be understood that this description is not intended to limit the invention to these exemplary embodiments. On the contrary, the invention is intended to cover not only the exemplary embodiments, but also various alternatives, modifications, and equivalents, which are included within the spirit and scope of the invention as defined by the appended claims.

An application scenario of a non-destructive testing method according to an embodiment of the present invention is a non-destructive testing for an Nb₃Sn CICC superconducting cable, especially a non-destructive testing for an Nb₃Sn CICC superconducting cable in a low temperature environment (for example, with temperature of 77K to 200K).

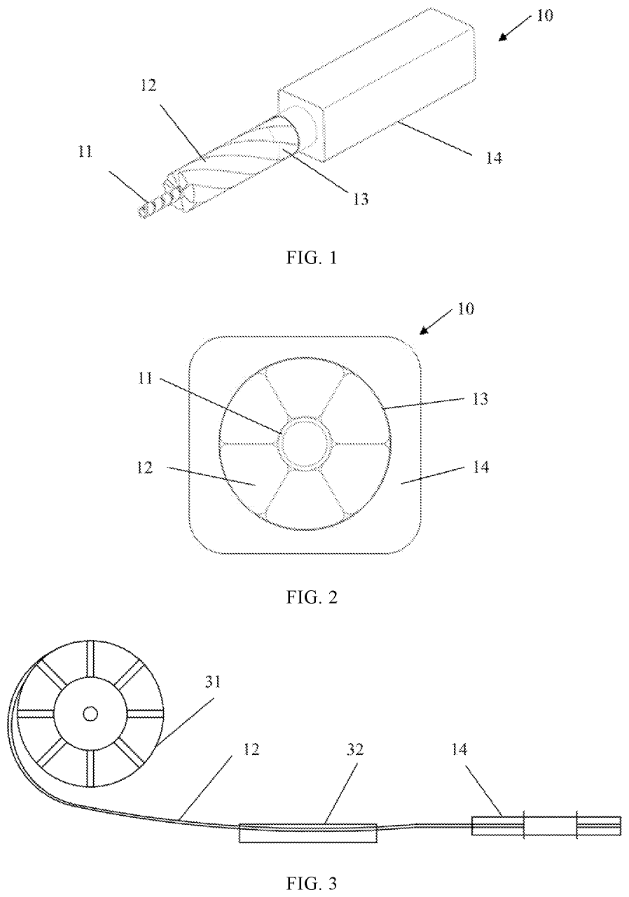

FIG. 1 is a schematic perspective view of a typical CICC to which a non-destructive testing method of damage assessment for a CICC superconducting cable according to an embodiment of the present invention may be applied. FIG. 2 is a schematic cross-sectional view of a typical CICC to which a non-destructive testing method for damage assessment for a CICC superconducting cable according to an embodiment of the present invention may be applied. FIG. 3 is a schematic diagram of an implementation scenario of a non-destructive testing method for damage assessment for a CICC superconducting cable according to an embodiment of the present invention.

As shown in FIG. 1 and FIG. 2, a CICC 10 includes a central helical tube 11, a superconducting cable 12, a wrapping tape 13 and an armor 14.

The central helical pipe 11 is a pipe made of metal, such as a stainless steel pipe. In the actual working process, a cryogenic fluid such as liquid helium may flow in the central helical tube 11, thereby reducing the temperature of the superconducting cable 12 and helping to maintain the superconducting state of the superconducting cable 12.

The superconducting cable 12 mainly plays the role of carrying current. For example, the superconducting cable is made by isotropic superconducting wire(s) and other metal wire(s) (such as copper wires) through 3 to 5 levels of twisting or stranding. For the case of 5-level stranding, an exemplary stranding process includes: stranding two (2) superconducting wires and one (1) copper wire to obtain a level-1 sub-cable; stranding three (3) level-1 sub-cables to obtain a level-2 sub-cable; stranding five (5) level-2 sub-cables to obtain a level-3 sub-cables; stranding 5 level-3 sub-cables and a copper core to obtain a level-4 sub-cable; stranding six (6) level-4 sub-cables to obtain a level-5 sub-cable; and wrapping the level-5 sub-cable with a stainless steel tape, that is, wrapping the wrapping tape 13 around the periphery of the level-5 sub-cable, to form a final superconducting cable. In the cable, for example, the copper core may include four (4) copper core cables, and each copper core cable may include three (3) copper sub-cables.

Those skilled in the art may understand that the above description of the superconducting cable is just an example. According to the actual application scenario, the superconducting cable may be made of thousands of small-diameter superconducting wires and metal wires through multi-level stranding, which may include patterned wrapping tape(s) and overlapped wrapping tape(s) wrapping certain level sub-cable(s) (for example, a patterned wrapping tape wrapping a level-4 sub-cable and an overlapped wrapping tape wrapping a level-5 sub-cable), so that finally a low-porosity, multi-strand and multi-level helical structure is formed without regular internal structure space. The length of a single superconducting cable may reach thousands of meters. For such a superconducting cable, it is difficult to apply a non-destructive testing technique of the related art for testing.

The armor 14 is a sleeve made of metal (e.g., steel) and mainly functions to protect and support the superconducting cable 12.

Referring to the implementation scenario of the embodiment of the present invention shown in FIG. 3, a stranded superconducting cable 12 is placed in a cable release spool 31. Then, the superconducting cable 12 is passed through a cryogenic container 32 and then combined with the armor 14. The non-destructive testing method according to the embodiment of the present invention may be performed in the cryogenic container 32, so as to perform a damage assessment for the superconducting cable 12 before it is combined with the armor 14, so as to ensure the quality of the final CICC.

Exemplary embodiments of the present invention provide a non-destructive testing method capable of performing non-destructive testing on a superconducting cable, for example, detecting whether a superconducting wire inside the superconducting cable is damaged or defective. During the working process, that is, in the presence of current in the superconducting wire, if the superconducting cable is damaged or defective, the current distribution on a certain section of the superconducting cable will change, so that the magnetic field distribution around the superconducting cable will change. According to a non-destructive testing method of the exemplary embodiment of the present invention, a spatial model is established according to a cable specimen, the magnetic field strength around the superconducting cable is measured by using a magnetic sensor array, then the current source distribution inside the superconducting cable is reconstructed by using an inversion method, and then a damage assessment for the superconducting cable is performed.

The specific steps of the non-destructive testing method according to the embodiment of the present invention are described below by taking the damage assessment for an Nb₃Sn CICC superconducting cable as an example. The Nb₃Sn CICC superconducting cable is a CICC superconducting cable including an Nb₃Sn superconducting wire, and is characterized by its low-porosity, multi-strand and multi-level helical structure and irregular internal structure space. The Nb₃Sn CICC superconducting cable is of great significance in the magnetic confinement nuclear fusion technology, and is also a typical object for the non-destructive testing method according to the embodiment of the present invention. Those skilled in the art will understand that, the exemplary Nb₃Sn CICC superconducting cable does not constitute a limitation to the present invention.

The non-destructive testing method according to the embodiment of the present invention includes a modeling step, which comprises building a spatial model of a cable specimen, and determining a relationship between a current source inside the cable specimen and a magnetic field around the cable specimen based on the spatial model.

In this step, according to the structural characteristics of an actual Nb₃Sn CICC superconducting cable, Finite Element Analysis (FEA) software (such as ABAQUS, ANSYS, etc.) is used to model the Nb₃Sn CICC superconducting cable specimen level by level.

For an Nb₃Sn CICC superconducting cable specimen including a level-5 sub-cable, a spatial geometric model of a level-1 sub-cable is firstly built. For example, a level-1 sub-cable is made by stranding 2 superconducting wires and 1 copper wire, and thus considering structure parameters (e.g., diameter, twist radius, twist angle, pitch, etc.) and material parameters of the superconducting wires and the copper wire, and using a first-order helix equation, the spatial geometric model of the level-1 sub-cable, that is, a parameter equation of the level-1 sub-cable, is built. Since a level-2 sub-cable is obtained by stranding 3 level-1 sub-cables, a space transformation matrix may be used to obtain a transition matrix from a first-order helix to a second-order helix; and then vector summation may be used to obtain a parameter equation of the second-order helix, so as to build a spatial geometric model of the level-2 sub-cable, that is, a parameter equation of the level-2 sub-cable. By analogy, a spatial geometric model of the Nb₃Sn CICC superconducting cable specimen including a level-5 sub-cable is finally obtained.

In other words, the components of the Nb₃Sn CICC superconducting cable specimen are divided into 5 levels, the level-1 sub-cable is the lowest level, and the level-5 sub-cable is the highest level. A level-by-level modeling from lower level to higher level is performed during the building of the spatial model, so that an accurate spatial geometric model of the superconducting cable with a complex structure may be obtained with high efficiency.

According to an exemplary embodiment of the present invention, modeling weights are set on components of the cable specimen, and the modeling weights are applied to the process of building the spatial model.

In the process of non-destructive testing for the superconducting cable, each component of the superconducting cable has different effects on the testing. Therefore, during modeling the Nb₃Sn CICC superconducting cable specimen, different modeling weights may be set for different components of the cable specimen, so as to improve the accuracy of the spatial geometric model of the superconducting cable.

For example, one or more of the patterned wrapping tape, the overlapped wrapping tape and the central helical tube of the Nb₃Sn CICC superconducting cable specimen may not be the key modeling object, while the Nb₃Sn superconducting wire and the copper wire may be the key modeling object. Therefore, a lower modeling weight may be set for one or more of the patterned wrapping tape, the overlapped wrapping tape and the central helical tube, and a higher modeling weight may be set for the Nb₃Sn superconducting wire and the copper wire. In addition, modeling weights may also be set for key parameters. For example, torque of each sub-cable has a great influence on the testing, so a higher modeling weight may be set for the torque.

According to an exemplary embodiment of the present invention, the modeling weight for one or more of the patterned wrapping tape, the overlapped wrapping tape and the central helical tube may be set to zero. In other words, one or more of the patterned wrapping tape, the overlapped wrapping tape and the central helical tube may not be considered in the modeling process. Through such modeling weight setting, the accuracy of the spatial geometric model of the superconducting cable for non-destructive testing may be improved.

The non-destructive testing method according to an embodiment of the present invention further includes determining relationship between the current source inside the cable specimen and the magnetic field around the cable specimen. Calculation for the magnetic field may use superposition of current segments, and numerical integration may be used to calculate the magnetic field generated by a complex current source. That is, firstly, a helical current source is divided into small straight wire current segments, and then the total magnetic field is obtained by accumulating magnetic fields generated by each current segment.

The non-destructive testing method according to an embodiment of the present invention includes a programming step, which comprises analyzing the relationship between the current source inside the cable specimen and the magnetic field around the cable specimen (i.e. a magnetic field strength equation) and obtaining a current source reconstruction program based on the analyzation, such as obtaining a current source reconstruction program based on a magnetic field strength equation.

According to an embodiment of the present invention, a conjugate gradient method may be used to iteratively solve the relationship (i.e. magnetic field strength equation) obtained in the preceding step to obtain the current distribution of the superconducting wire inside the cable specimen. For example, the magnetic field strength equation is firstly transformed into an optimization problem, and then iteratively iterations are performed within a selected accuracy range until a best approximate solution to the optimization problem is obtained. Based on the above steps, a current source reconstruction program is obtained.

The non-destructive testing method according to an embodiment of the present invention includes a pick-up step, which comprises using a plurality of magnetic sensors to pick up magnetic field signals around the superconducting cable. The plurality of magnetic sensors form a circular magnetic sensor array 40 on a plane perpendicular to the axis of the superconducting cable, and are uniformly distributed in the circumferential direction, so as to pick up magnetic field signals on a cross-section of the superconducting cable.

In the actual working process of CICC, the superconducting cable carries current, which will generate heat therein, and the heat will influence the physical properties of the superconducting cable, and influence the current distribution inside the superconducting cable and the magnetic field distribution outside the superconducting cable. In order to eliminate such influence and interference of the heat on non-destructive testing, according to an embodiment of the present invention, during the pick-up step, the superconducting cable or its part to be tested may be placed in liquid nitrogen or liquid helium, so as to decrease the temperature of the superconducting cable or its part to be tested when it is carrying current.

According to an embodiment of the present invention, in order to detect the magnetic field distribution in various directions on a cross section of the superconducting cable, a plurality of magnetic sensors may be evenly arranged in the circumferential direction of the superconducting cable, and number of the magnetic sensors is generally 24 to 48. The number of the magnetic sensors may affect the accuracy and resolution of the magnetic field distribution measurement; the higher the number, the more accurate the reconstruction, but the higher the cost and complexity. On the basis of considering a balance between performance and cost, the embodiment of the present invention adopts 24 to 48 magnetic sensors.

The magnetic field signals picked up by the magnetic sensors include magnitude of magnetic field strength.

According to an embodiment of the present invention, the diameter of the superconducting cable is 32.6-39.7 mm (the diameter of the superconducting cable does not constitute a limitation to the present invention), and the distance between the magnetic sensor and the superconducting cable is 1 mm to 10 mm. In the working state, the temperature of Nb₃Sn CICC superconducting cable is 77K to 200K. Too small the distance between the magnetic sensor and the superconducting cable will cause the magnetic sensor to fail or be damaged due to low temperature, and too large the distance will cause the magnetic sensor's signal strength to drop.

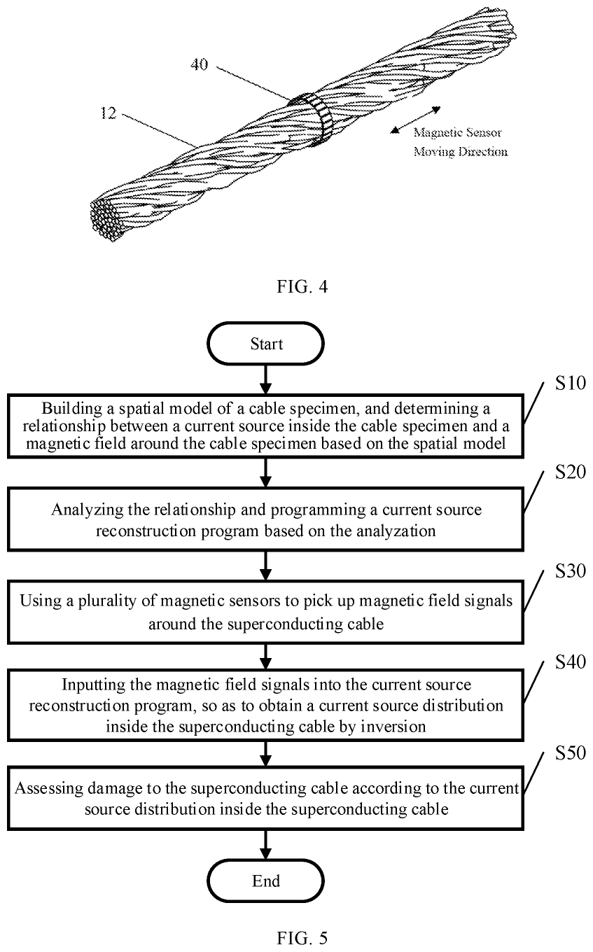

FIG. 4 is a schematic diagram of an implementation process of a non-destructive testing method for damage assessment for a CICC superconducting cable according to an embodiment of the present invention, showing the arrangement of a superconducting cable and a magnetic sensor array.

During the pick-up step, the circular magnetic sensor array 40 may be moved relative to the superconducting cable 12 in the axial direction of the superconducting cable 12 or the superconducting cable 12 may be moved relative to the circular magnetic sensor array 40 in the axial direction of the superconducting cable 12, as shown in FIG. 4. Also, the magnetic field signals around the superconducting cable may be picked up continuously or at a predetermined rate suitable for the magnetic sensor.

According to an embodiment of the present invention, the moving speed of the Nb₃Sn CICC superconducting cable 12 or the circular magnetic sensor array 40 is 0.5 m/min to 10 m/min.

The non-destructive testing method according to an embodiment of the present invention includes an inversion step, which comprises inputting the magnetic field signals picked up by the circular magnetic sensor array into the current source reconstruction program, so as to obtain a current source distribution inside the superconducting cable by inversion.

In other words, according to the current source reconstruction program built in the programming step, the internal current source reconstruction of the cable is performed using the magnetic field signals picked up in the pick-up step.

For example, based on the spatial geometric model of the superconducting cable, numerical integration is used to calculate the magnetic field generated by the complex current source, the corresponding transformation matrix is used to obtain the magnetic induction intensity of each magnetic field measuring point (i.e., each magnetic sensor position) in a global coordinate system, and finally a conjugate gradient method is used to iteratively solve the electromagnetic equation, so as to obtain the current distribution in the superconducting cable.

The non-destructive testing method according to an embodiment of the present invention includes an assessing step, which comprises assessing damage to the superconducting cable according to the current source distribution inside the superconducting cable.

According to the current source distribution inside the superconducting cable obtained in the inversion step, and referring to the relationship between the current source inside the cable specimen and the magnetic field around the cable specimen built in the modeling step, the internal damage and breakage of the superconducting cable are determined.

For example, for a superconducting cable comprising 5 superconducting wires, with respect to an indefective and non-damaged cable specimen, if a current of 5 A is passed through each superconducting wire (either through actual energization testing or through modeling analysis), a current distribution of 5 A-5 A-5 A-5 A-5 A will be formed. In the assessing step, if it is found that the current source distribution inside the superconducting cable is 6.25 A-0 A-6.25 A-6.25 A-6.25 A, it means that there is a current redistribution and the superconducting cable presents damage or breakage of the superconducting wire.

FIG. 5 is a flowchart of a non-destructive testing method for damage assessment for a CICC superconducting cable according to an embodiment of the present invention.

As shown in FIG. 5, the non-destructive testing method for damage assessment for a CICC superconducting cable according to an embodiment of the present invention comprises:

S10: modeling step, which comprises building a spatial model of a cable specimen, and determining a relationship between a current source inside the cable specimen and a magnetic field around the cable specimen based on the spatial model;

S20: programming step, which comprises analyzing the relationship and programming a current source reconstruction program based on the analyzation;

S30: pick-up step, which comprises using a plurality of magnetic sensors to pick up magnetic field signals around the superconducting cable;

S40: inversion step, which comprises inputting the magnetic field signals into the current source reconstruction program, so as to obtain a current source distribution inside the superconducting cable by inversion; and

S50: assessing step, which comprises assessing damage to the superconducting cable according to the current source distribution inside the superconducting cable.

The invention provides a non-destructive testing method for on-line/real-time measurement to damage to an Nb₃Sn CICC superconducting cable by using a magnetic flux leakage method at low temperature. Without destructive effect to the superconducting cable, the distribution of the magnetic field strength around the superconducting cable is measured, the current source distribution inside the cable is reconstructed by signal inversion, and then the damage to the superconducting cable is inferred. According to an embodiment of the present invention, an on-line/real-time non-destructive measurement to a superconducting cable may be performed at low temperature, so as to realize qualitative and quantitative testing of damage to the superconducting cable over the destructive testing method on a short specimen for detecting damage to a superconducting wire inside the superconducting cable in the related art; and the present invention may be widely used in the on-line/real-time detection of the superconducting cable.

The foregoing has presented specific exemplary embodiments of the invention by way of illustration. The above description is not intended to be exhaustive of the invention, nor is it intended to limit the invention to the exact form disclosed. Obviously, many modifications and variations may be made by those skilled in the art in light of the above description. The exemplary embodiments were chosen and described in order to explain certain principles of the invention and its practical application, to thereby enable those skilled in the art to make and use various exemplary embodiments of the invention, as well as various alternatives and modifications. Instead, the scope of the invention is defined by the appended claims and their equivalents.

1. A non-destructive testing method for damage assessment for a superconducting cable, comprising the following steps:
a modeling step of building a spatial model of a cable specimen and determining a relationship between a current source inside the cable specimen and a magnetic field around the cable specimen based on the spatial model;
a programming step of analyzing the relationship and programming a current source reconstruction program based on the analyzation;
a pick-up step of using a plurality of magnetic sensors to pick up magnetic field signals around the superconducting cable;
an inversion step of inputting the magnetic field signals into the current source reconstruction program, so as to obtain a current source distribution inside the superconducting cable by inversion; and
an assessing step of assessing damage to the superconducting cable according to the current source distribution inside the superconducting cable.

2. The non-destructive testing method for damage assessment for the superconducting cable of claim 1, wherein the modeling step comprises:
dividing components of the cable specimen into a plurality of levels, and performing level-by-level modeling from a lower level to a higher level during building the spatial model.

3. The non-destructive testing method for damage assessment for the superconducting cable of claim 2, wherein the modeling step comprises:
setting modeling weights on the components of the cable specimen, and applying the modeling weights to building the spatial model.

4. The non-destructive testing method for damage assessment for the superconducting cable of claim 3, wherein the cable specimen comprises an overlapped wrapping tape and a central helical tube, and the modeling weights for the overlapped wrapping tape and the central helical tube are set to zero.

5. The non-destructive testing method for damage assessment for the superconducting cable of claim 1, wherein the plurality of magnetic sensors form a circular magnetic sensor array on a plane perpendicular to an axis of the superconducting cable, and are uniformly distributed in a circumferential direction, so as to pick up the magnetic field signals on a cross-section of the superconducting cable.

6. The non-destructive testing method for damage assessment for the superconducting cable of claim 5, wherein the circular magnetic sensor array comprises 24 to 48 magnetic sensors.

7. The non-destructive testing method for damage assessment for the superconducting cable of claim 5, wherein the magnetic field signals comprise a magnitude of magnetic field strength.

8. The non-destructive testing method for damage assessment for the superconducting cable of claim 5, wherein a distance between each of the plurality of magnetic sensors and the superconducting cable is 1 mm to 10 mm.

9. The non-destructive testing method for damage assessment for the superconducting cable of claim 5, wherein the pick-up step further comprises: moving the circular magnetic sensor array relative to the superconducting cable in an axial direction of the superconducting cable, or moving the superconducting cable relative to the circular magnetic sensor array in the axial direction of the superconducting cable, and picking up the magnetic field signals around the superconducting cable at a predetermined rate.

10. The non-destructive testing method for damage assessment for the superconducting cable of claim 9, wherein a moving speed of the circular magnetic sensor array or the superconducting cable is 0.5 m/min to 10 m/min.
